(19) United States
(12) Patent Application Publication
(10) Pub. No.: US 2013/0144745 A1
(43) Pub. Date: Jun. 6, 2013

(54) METHOD AND APPARATUS FOR MANAGING A SUPPLY CHAIN

(71) Applicants: Matthew John Henderson, London (GB); Ryan Timothy Regan, London (GB)

(72) Inventors: Matthew John Henderson, London (GB); Ryan Timothy Regan, London (GB)

(21) Appl. No.: 13/353,969

(22) Filed: Jan. 19, 2012

Related U.S. Application Data
(60) Provisional application No. 61/566,883, filed on Dec. 5, 2011.

(51) Int. Cl. G06Q 30/00

(52) U.S. Cl. 705/26.2

(57) ABSTRACT

A supply chain management platform. Product information is gathered to create a product catalog having atomic product records. The product records are linked to product offers from suppliers. A retailer can select product for integration into the retailer's product catalog. Orders from retailers are matched to product offers and assigned to the corresponding supplier for fulfillment of the order. Retailers and suppliers are given visibility in to the system to maximize efficiencies.

### RELATED APPLICATION DATA

This application claims priority to U.S. Provisional Patent Application Ser. No. 61/566,883, filed Dec. 5, 2011, which is hereby incorporated by reference in its entirety.

### COPYRIGHT NOTICE

A portion of the disclosure of this patent document contains material which is subject to copyright protection. The copyright owner has no objection to the facsimile reproduction of the disclosure, as it appears in the Patent and Trademark Office patent file or records, but otherwise reserves all copyright and other rights.

### BACKGROUND

Electronic commerce or “ecommerce”, particularly in the retail space, has become ubiquitous over the last decade. Virtually every retailer, even those of small scale, have an online presence with an ecommerce component. Amazon.com™ is an example of a very large retailer, a “mega retailer”, that has an online product catalog that spans all types of tangible goods, such as consumer electronic devices and books, as well as digital media, such as videos and ebooks. Amazon.com™ has a large network of suppliers. Also, Amazon.com™ provides a mechanism for integrating the product offerings of retailers into the Amazon.com catalog, making the retailer an “Amazon Merchant” or “Marketplace Seller”. In this scenario, the retailer receives orders through Amazon.com™ and processes those orders in a conventional manner or Amazon.com™ fulfills the order.

The range of products offered by mega retailers is not matched by most other retailers. Most retailers have specific specialty area in which they have experience and relationships. In order to remain competitive with mega retailers, smaller retailers are increasingly interested in expanding existing product categories and adding new categories to their online catalog. To add products, the retailers typically have three options.

The first option is to add the products to their existing catalog by establishing new business relationships and technical integrations with suppliers, gathering the catalog information, and adding other internal capabilities necessary to accommodate sales of the new products (such as shipping, tracking, return processing and the like). This is a cumbersome process and is especially difficult when a retailer wishes to add a new category of products that have different characteristics and requirements when compared to the retailer's existing product line. As an example, a retailer of clothing who wants to expand into consumer electronic devices will have to deal with new technology export and recycling issues, packaging requirements, warehouse requirements, and the like, in addition to establishing new relationships with suppliers and aggregating catalog information. Typically, supplier integration requires evaluating the supplier's cost competitiveness, reputation, product offering, delivery reliability and the like. Once this has been accomplished an agreement must be negotiated between the parties. Further, technical integrations are required to interface the retailer's system with each new supplier, and vice versa. It can be seen that such an undertaking requires a great deal of time and investment, and presents significant risk for both the supplier and the retailer.

The second option is to use a “white label” turnkey services provider. In such a case, the service provider has an online store that can be branded as the retailer's own and which can have broader range than the existing product line of the retailer. However, this option requires that the retailer outsource their entire on-line store to the white label store service provider. This is often not acceptable or pragmatic, especially for retailers having a large existing online retail presence.

The third option is to become a selling partner of one of the mega retailer sites, such as Amazon.com™, whereby the retailer's product catalog becomes part of the mega retailer's platform. However, this is more of a “if you can't beat them, join them” approach as it does not really expand a retailer's product offerings but makes a retailer's existing product offerings part of a larger platform. This option also is not acceptable to many larger scale retailers or other retailers trying to maintain a strong brand.

Currently, the “friction” in expanding product offerings is quite high. This has made it quite difficult for retailers to expand product offerings in a meaningful way.

### BRIEF DESCRIPTION OF THE DRAWINGS

FIG. 1A is a schematic illustration of a supply chain platform and relationships between the platform and other parties.

FIG. 1B is a flowchart of a workflow of the supply chain platform.

FIG. 2 is an example of a top level of a catalog taxonomy.

FIG. 3 illustrates a product record of a catalog.

FIG. 4 is a user interface for submitting offer information.

FIG. 5 is a user interface for viewing offers.

FIG. 6 is a user interface for managing orders.

FIG. 7 is a user interface for selecting products and categories.

FIG. 8 is a user interface for creating retailer rules.

FIG. 9 is a log of order status.

While systems and methods are described herein by way of example and embodiments, those skilled in the art will recognize that systems and methods are not limited to the embodiments or drawings expressly described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

### Overall Platform Operation

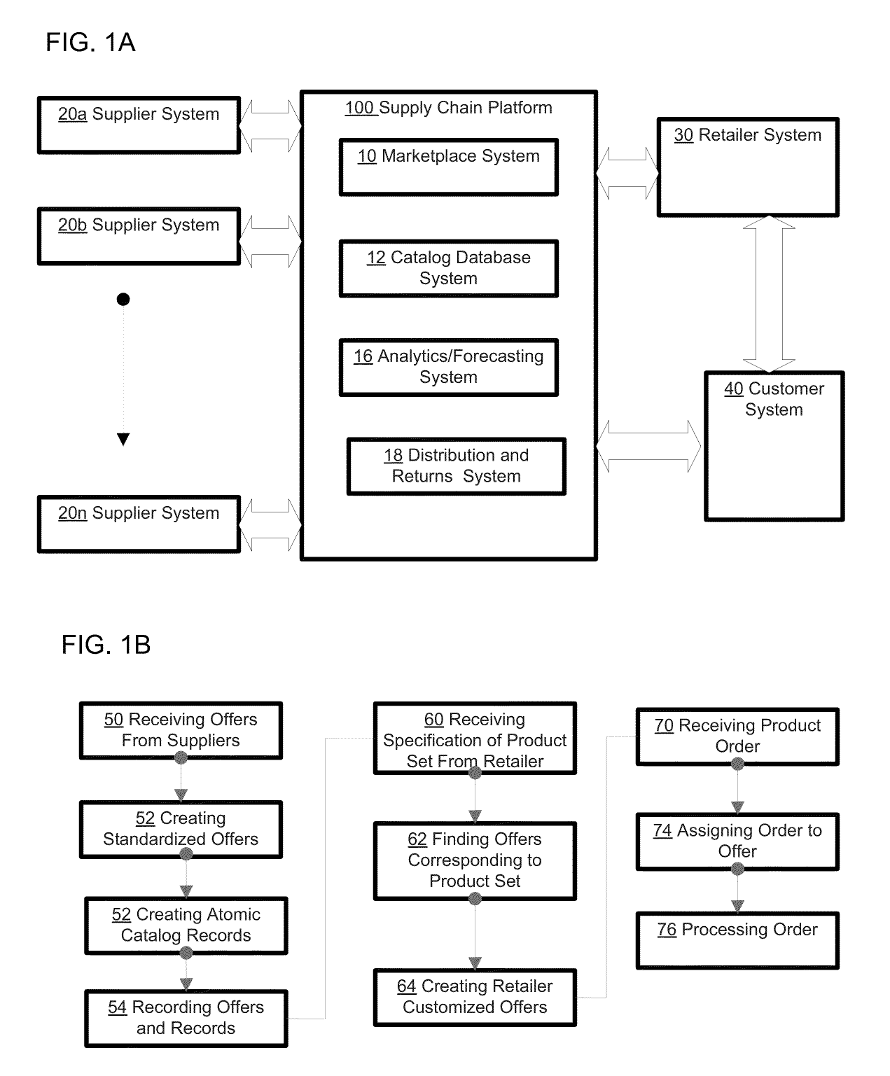

FIG. 1A is a block diagram of an embodiment of a supply chain platform and other parties that communicate with the platform. Supply chain platform 100 can be implemented as one or more computing devices programmed in an appropriate manner. Supply chain platform 100 includes multiple systems described below, each of which can also be implemented as one or more computing devices programmed in an appropriate manner. Note that the systems need not be implemented on distinct devices but are segregated herein by function for convenience of description.

Supply chain platform 100 communicates with multiple supplier systems 20a, 20b . . . 20n, which are computer systems associated with a supplier of products. It should be noted that the term “product” is used herein to refer to any item, including physical items, digital content, and services. Supply chain platform 100 also communicates with at least one retailer system 30, which is a computer system associated with a retailer of products. Retailer system 30 can communicate with customer system 40, which is a system of a purchaser of products from a retailer or supply chain platform 100, in a known manner. Also, customer system 40 can communicate directly with supply chain platform 100. The term “communicate’ as used herein refers to any mechanism for transferring information. For example, systems can communicate through computer-to-computer protocols or through user entry of data from one system into another system.

Supply chain platform 100 includes marketplace system 10 which provides various functionality, described in greater detail below, regarding matching and processing of orders. Supply chain platform 100 also includes catalog database system 12 which provides various functionality regarding collecting aggregating, processing and storing of product and product category information. Supply chain platform 100 also includes analytics/forecasting system 16 which provides various functionality regarding the collection and processing of market data and forecasting of information related to market activity such as inventory needs, supply demand curves, and the like. Supply chain platform 100 also includes distribution and returns system 14, which provides various functionality regarding shipping of products, returns processing and other logistical matters. The function of each of these systems is described in greater detail below.

FIG. 1B is a flowchart of an example workflow of supply chain platform 100. In step 50, supply chain platform 100 receives product information, in the form of offers from suppliers for example. Offers include at least a product and pricing and are described in greater detail below. In step 52, supply chain platform 100 standardizes the product information into a standard format. Alternatively, the received information can already be in the standardized format. In step 52, the information is used to create atomic catalog records, i.e. a single record for each product as described in greater detail below. In step 54, the atomic records, and corresponding standardized offers are recorded and linked as described below. Steps 50-54 constitute a catalog creation process.

In step 60, supply chain platform 10 receives a product specification set from a retailer to select products that the retailer would like to integrate into a retailer catalog. In step 62, offers are identified that correspond to the products. In step 64, retailer customized offers are created based on the selected products and rules or other attributes specified by the retailer, as described in greater detail below, for integration into the retailer catalog. Steps 60-64 constitute a product selection and integration process.

In step 70, supply chain platform 100 receives orders from retailers. In step 74, the orders are assigned a supplier based on supplier offers and retailer requirements, as described in greater detail below. In step 76, the order is processed and shipped to a customer. Steps 70-74 constitute and order process and fulfillment process. Each step of FIG. 1B, and the corresponding systems that perform those steps, are described in detail below.

### Catalog

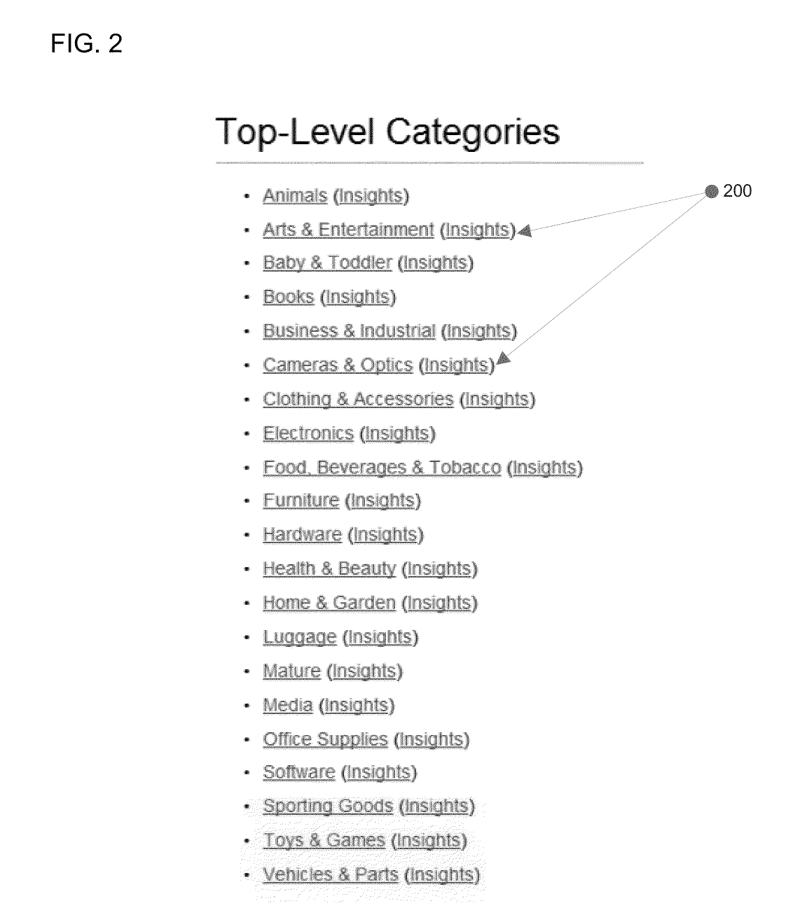

Catalog database system 12, integrates product information from various sources into a product catalog having a category taxonomy and a normalized product record for each product. The sources can include supplier systems 20a-20n, manufactures and other sources, such as web sites. The product information can be obtained by crawling web sites, receiving data through APIs, receiving data through a user interface, or in any manner. FIG. 2 illustrates top-level categories 200, only some of which are labeled, of an example of the catalog taxonomy created and maintained by catalog database system 12. Of course, the taxonomy can have subcategories also to define a tree-like structure or other arrangement.

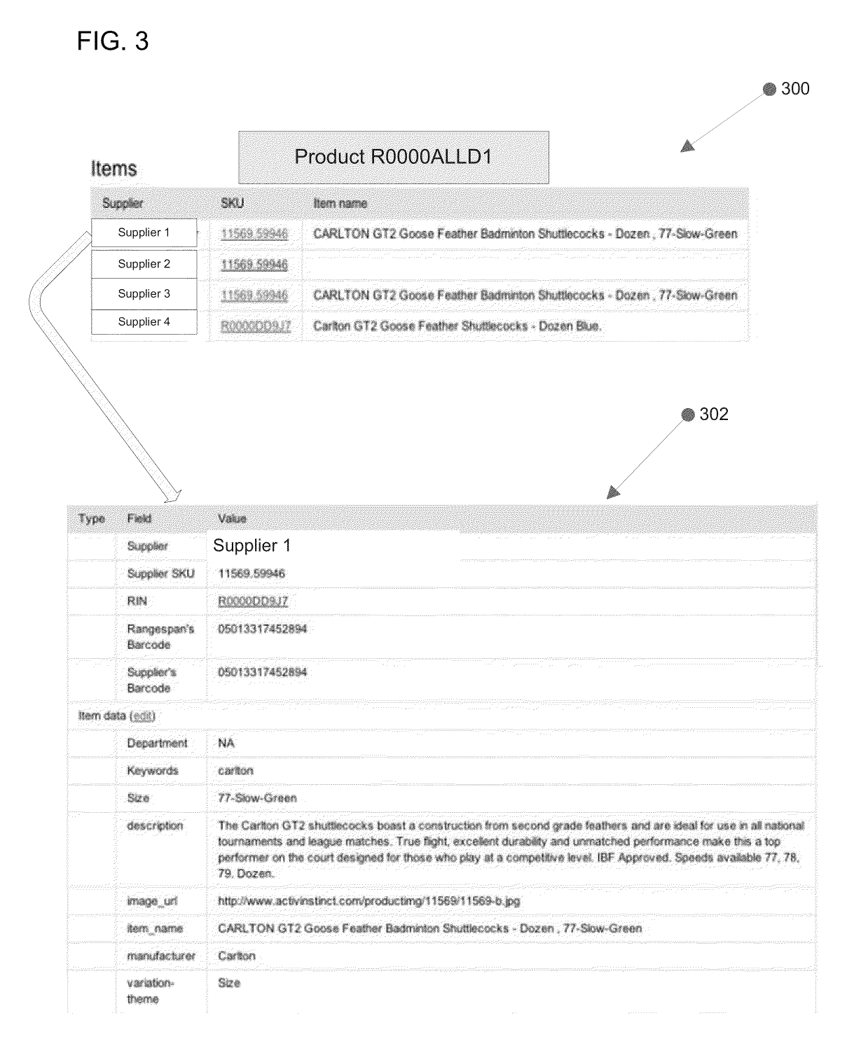

FIG. 3 illustrates a rendering of a product record for an item in the catalog of catalog database system 12. Product record 300 includes information for a single product, from four supplier offers in this example. The information is normalized to a single product identifier, referred to as RIN herein. Supplier offer information 302 is linked to product record 300. As can be seen, the offer information can include attributes such as product cost, shipping cost, weight, supplier product identification (such as SKU and barcode) and other product information. Of course, product record 300 can include other product information such as product attributes and product descriptions. Further, supplier offer information 302 can include inventory, shipping times and any other information relating to the product as will become apparent below. The catalog can be stored as a relational database, a flat database or in any other format as is well known in the art.

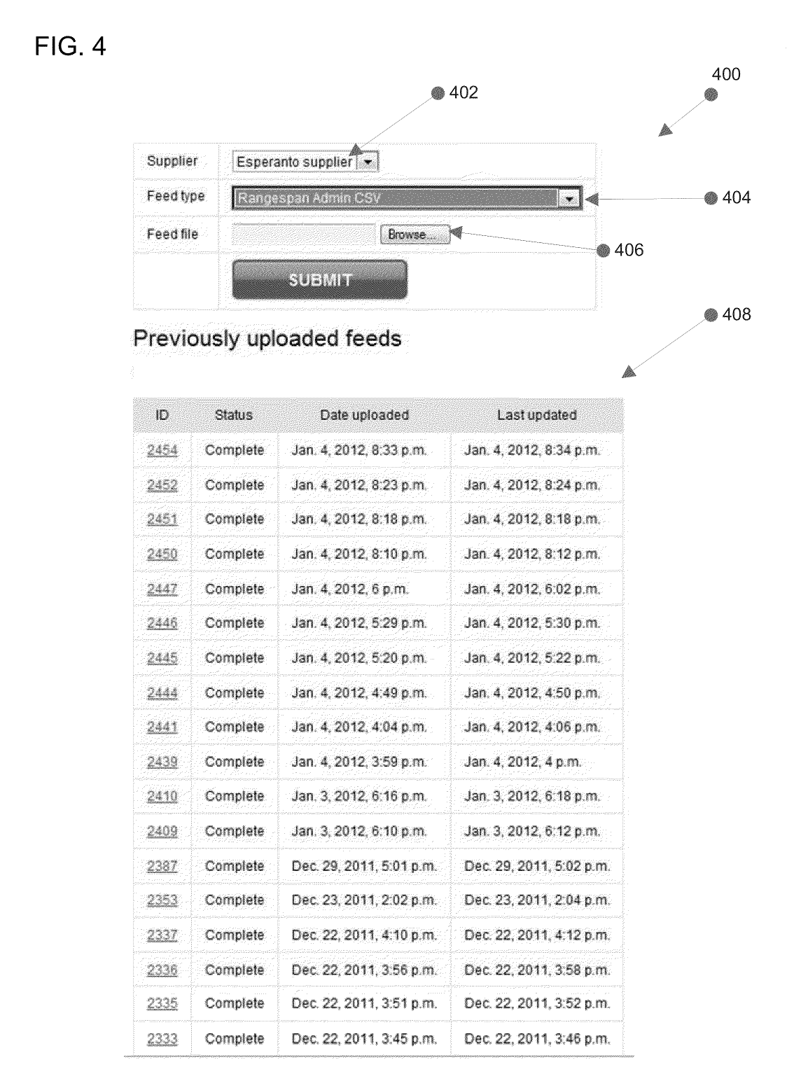

Suppliers associated with supplier systems 20a-20n, hereinafter referred to collectively and individually as supplier, can submit offer information to supply chain platform in various manners. FIG. 4 illustrates a user interface of catalog database system 12 that can be used to submit offer information. A suppler can use supplier system 20 to access a web page which displays interface 400. The supplier can indicate their identity in field 402 and specify a feed type in field 404 and feed file to be uploaded in field 406. The feed type can be selected from various standard or proprietary formats such as CSV, Excel, or the like. Once uploaded, the feed information is mapped, in a known manner, by catalog database system 12 and stored. As is shown, a listing of the dates and times of previous feeds can be provided at 408. As noted above, offer information can be provided in any manner, such as by uploading a feed, or though an API in an automated manner. An example of an API specification for submitting offers is included in the Appendix attached hereto.

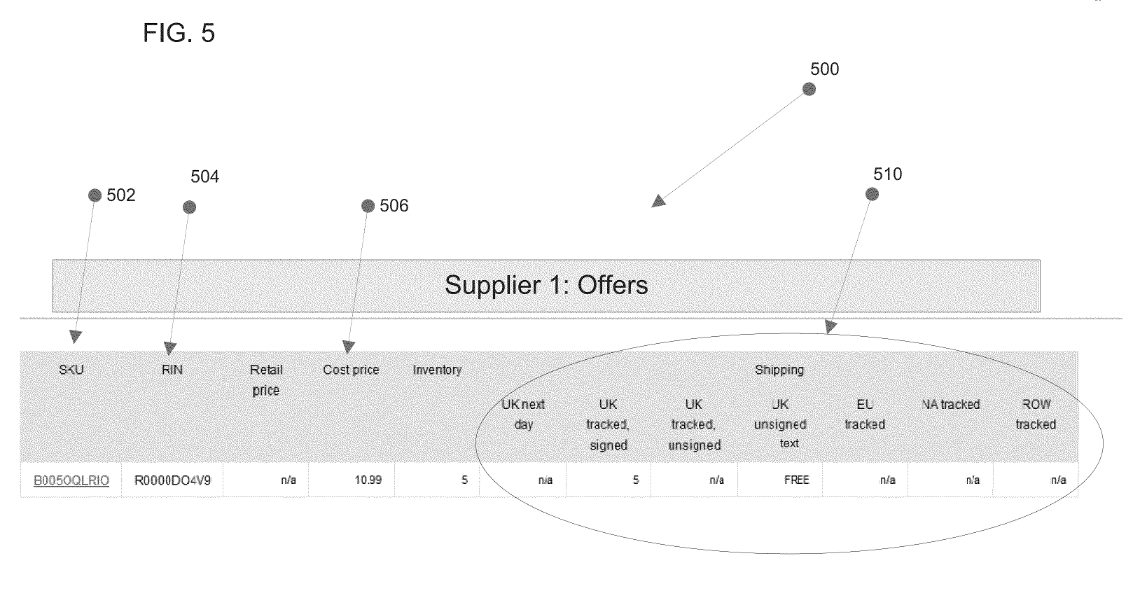

FIG. 5 illustrates an interface of catalog database system 12 for permitting a supplier to view their offers. As noted above, an offer includes a specific product and at least pricing information for the specific product. Offer 500 includes an SKU at 502 and the standardized RIN at 504, which links the offer with a product in the catalog as discussed above. Offer 500 also includes cost 506 at which the supplier will sell the product, inventory information 508, and delivery costs 510 for various types of delivery. In FIG. 5, only one offer is shown for Supplier 1. However, it is apparent that a supplier can have many offers, each corresponding to a different product. Also, multiple offers could exist for a single product from a supplier where the offers vary based on quantities ordered or delivery timing. For example, Supplier 1 could have two offers for a single product, one offer having a first price if the product is purchased in large lots and a second offer having a second price if the product is ordered in small quantities. Of course, this variable pricing could be addressed by a single offer having a different data structure including two prices.

Additionally, a supplier could be given limited access to information related to offers of other suppliers, such as whether their price for a product, or a range of products, is relatively high or low as compared to other suppliers. Suppliers can be given information from analytics/forecasting system 16 that allows them to be more profitable and competitive at the same time. For example, if Supplier 1 has 100 offers and 10 of those offers are only slightly higher in price than other suppliers; these 10 offers can be grouped and presented to Supplier 1 as offers that could sell more products if they were lowered in price slightly. Of course, various types and amounts of information can be provided to make the platform efficient. Historical data of offers and orders from retailers (described below in greater detail) can be provided by analytics/forecasting system 16. For example, a “hypothetical demand curve” can be presented indicating to a supplier what their likely sales volume of a product will be at various costs.

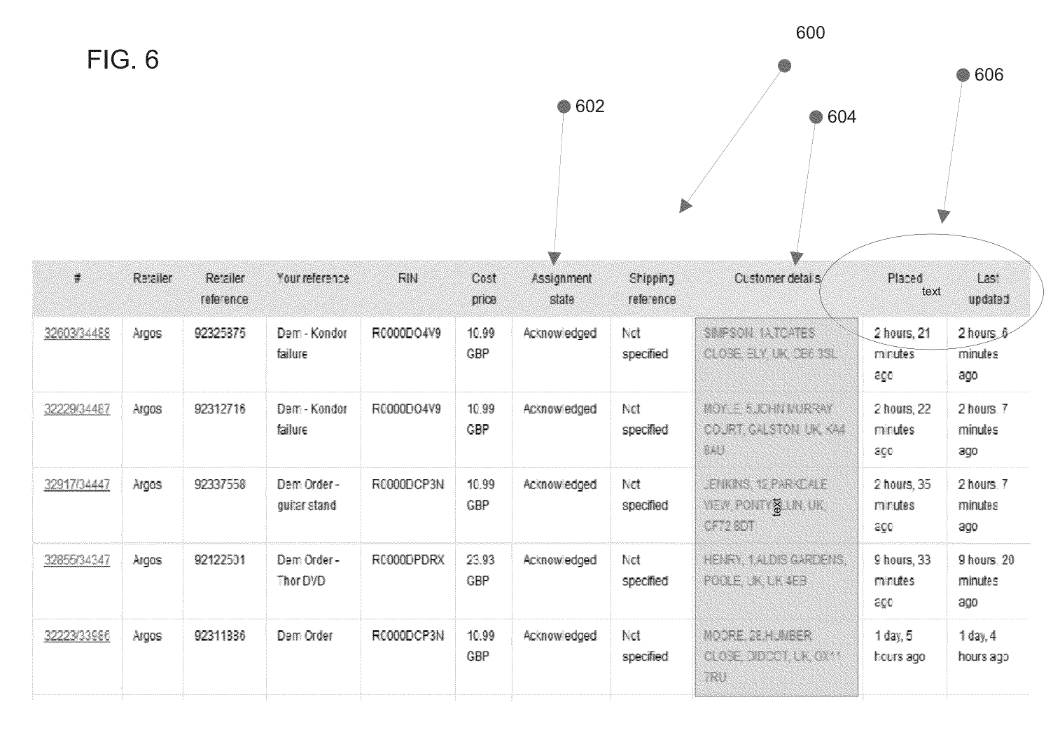

FIG. 6 illustrates a user interface for managing orders. Interface 600 includes information for multiple orders corresponding to a supplier. Orders, which are discussed in greater detail below, correspond to purchases, by customer of a retailer, of products from the supplier. As discussed below, orders originate when the platform assigns a retailer purchase request to an offer by a supplier. The information in interface 600 includes status 602 of the assignment state, customer details 604, and timing information 606. Of course, any relevant data can be included in interface 600. The information in interface 600 can also be communicated to a supplier system through an API or other computer-to-computer interface.

Interface 600 allows a supplier to manage orders and understand the status thereof in substantially real time. An interface can be provided to allow the supplier to update the status or other information. For example, when the supplier ships products, the corresponding order Assignment State can be updated from Acknowledged to Shipped. A packing slip can be generated based on the order information and can be branded for the retailer who placed the order. In this manner, a retailer can have products shipped directly from a supplier to a customer of the retailer and the order will appear to have been shipped by the retailer. Also, returns processing information can be generated in a similar manner to appear to be handled by the retailer. Returns processing is discussed in greater detail below.

### Retailer

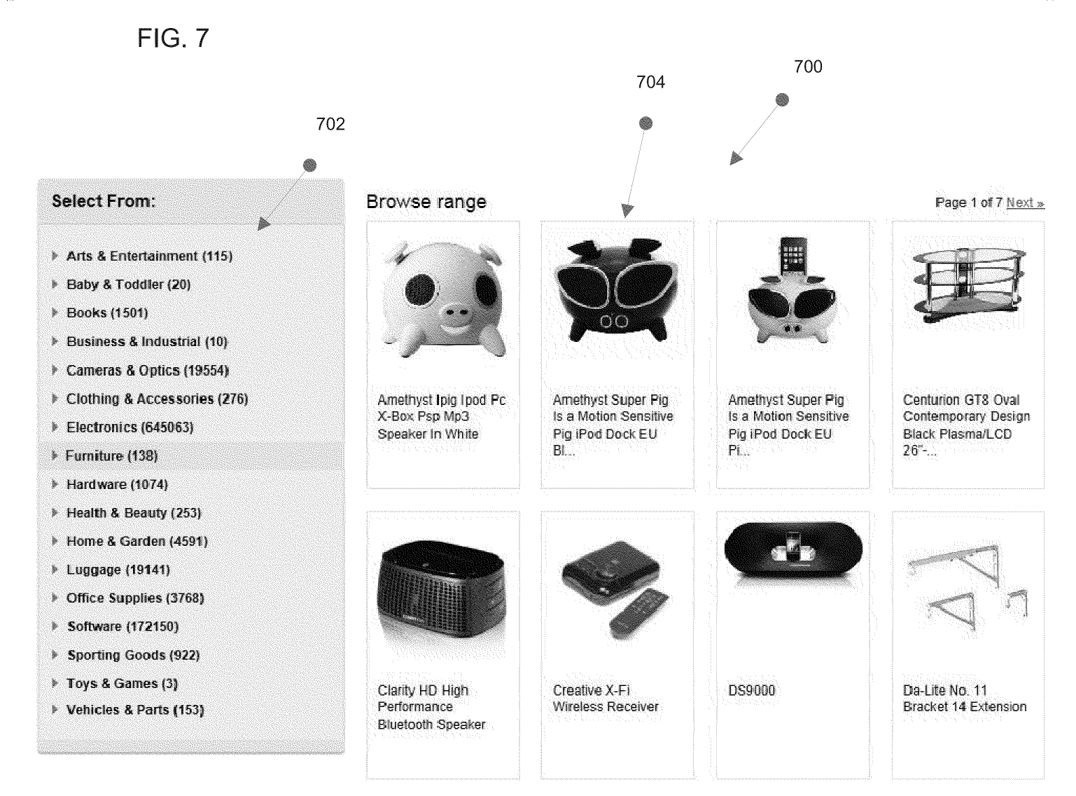

Retailers can select products, or product categories, from catalog database system 12 to add to their online offering through a user interface presented on retailer system 30 by catalog database system 12. FIG. 7 illustrates interface 700 for product/category selection by a retailer. A retailer can select an entire product category from taxonomy 702 or select individual products, such as the product indicated at 704. Selection can be through any user interface mechanism, such as check boxes, mouse click/highlight, and the like. Interface 700 can permit a retailer to drill down on products to get more detailed information about the product form the catalog.

Various sorting algorithms can be used to present products in interface 700 in a manner that makes selection more efficient. For example, products can be sorted in order of viewing in search engine results or product comparison web sites to preset the most popular products in priority. As another example, web analytics can be applied to data mined from the web, such as user reviews and the like, to understand sentiment about a product. This sentiment can be used to present product for selection in a prioritized manner. Further, the products can be presented for selection in a manner that does not produce redundancy in the retailer catalog by comparing the products with the retailer catalog and only presenting products that are not in the retailer catalog. Also, historical sales data can be used to determine products that are often purchased together, such as accessories, and products that correspond to the retailers existing products can be presented for selection.

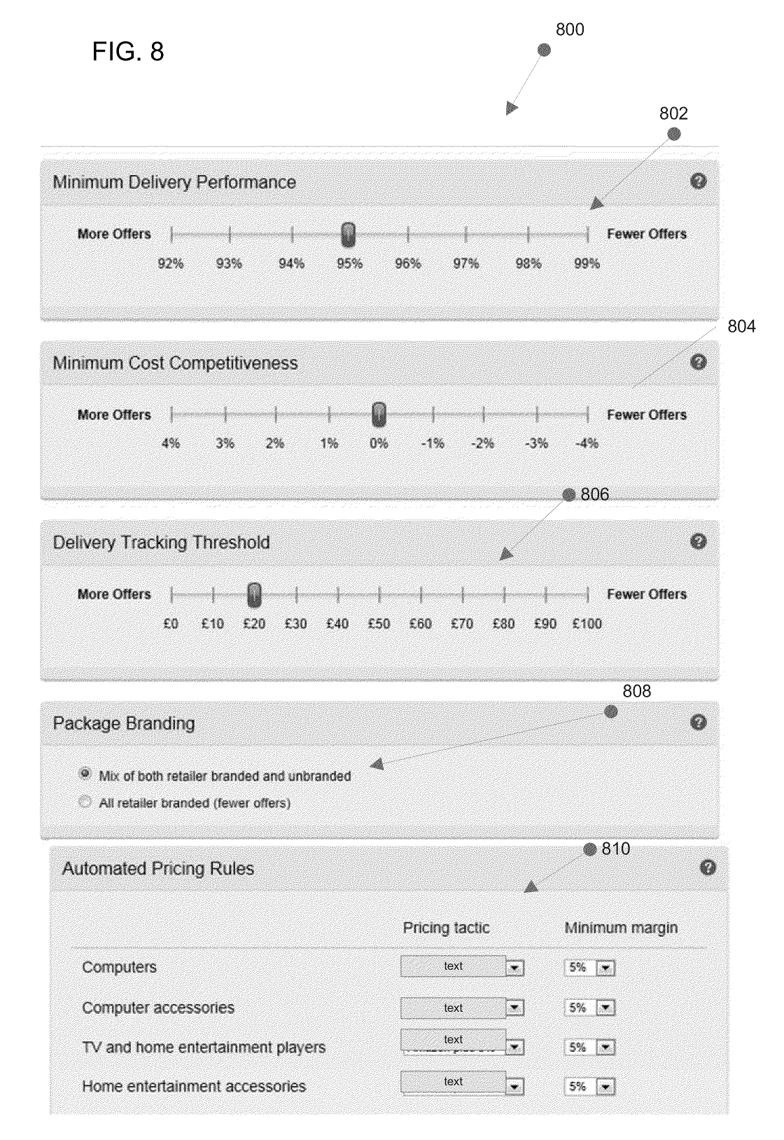

To further facilitate selection of products and profitability, catalog system 12 can apply retailer-selected rules to present products in interface 700. The rules can be applied as filters to the catalog to present only products associated with offers that satisfy the rules. FIG. 8 illustrates interface 800 for facilitating the creation of retailer specific rules. Interface 800 utilizes slider bars and radio buttons. However, any known user interface mechanisms can be used, such as text boxes, list boxes, dials, and the like. The rules can also be used for assigning orders to suppliers as discussed in greater detail below.

For example, a retailer can specify a percentage of on time delivery, using slider 802, required from supplier(s) based on historical performance from analytics/forecasting system 16. Of course, the higher the performance, the fewer offers that will satisfy the rule. Another slider 804 is presented to specify cost competitiveness based on a coast index, such as a competitors pricing. A third slider 806 allows selection of a threshold minimum purchase under which a supplier will provide delivery tracking A radio button selector 808 allows a retailer to select offers that permit branding (such as packaging and packing slips) to be all retailer branding or co branded with a supplier.

Also, automated pricing rules can be created through drop down lists at 810. For each category, or for individual products, a pricing tactic and minimum margin can be selected. Pricing tactics can be based on competitor pricing or a pricing index. A pricing tactic could specify that a customer price must be equal to a competitor's customer price. Minimum margin indicates a minimum margin that the retailer will accept while meeting the pricing tactic. For example, a pricing tactic could specify that the retailer price for a product must be less than or equal to 5% greater than a price of a mega retailer. The corresponding minimum margin could specify that the retailer must obtain at least a 5% margin on a sale of that product. In this case only products having supplier offers satisfying these conditions will be presented to the retailer for selection and these same conditions will be applied when assigning a supplier to an order from a customer of the retailer as described below. The selected products and rules are communicated to the supply chain platform 100 as a product specification. The specification includes preferences such as product type, brand, price-range, price-competitiveness, supplier ethical status, and delivery performance preference.

Once a retailer has selected products and/or categories to be integrated in the retailer's catalog, the integration process can occur. In one embodiment, there are three elements that must be integrated; item data, availability/cost data, and order data. For item data, the retailer provides platform 10 with an example file of attributes and formatting that can be uploaded to the catalog software of the retailer. Catalog database system 12 generates this file for all of the items in the retailer selection. Typically this would mean attributes from catalog database system 12 are mapped to the retailer file format. Some transformation may also be required. For example, the attribute “style” may map to the retailer's attribute “fit” or “item name” in catalog database system 12 may permit up to 300 characters, but the retailer's “product name” attribute may only permit 60 characters. Retailer system 30 receives a batch of data that can easily be used to create product records in retailer system 30. The files will typically be delivered to a server of retailer system 30, where the retailer's catalog software can automatically pick it up, through an API for example. However, the file can be downloaded manually, through FTP or the like.

For availability and cost data, a file with a list of product SKUs (using the retailer's own SKU nomenclature) is sent to the retailer for upload into retailer system 30 on a periodic basis, such as hourly. Again, the upload can be automatic or manual, such as through API's, FTP or manually entered into retailer system 30. For order data, catalog database system 12 specifies a minimum set of attributes that the retailer needs to send to place orders with supply chain platform 100. For example, an order reference number, SKU, customer name and address might be required. This set of minimum attributes can be sent via FTP as a text file, as an email attachment, or in any other manner. As the fulfillment of an order progresses, status updates can be sent from marketplace system 12 to retailer system 30 using the same FTP server method, as a regular email attachment, or through an API or web interface, such as interface 600 of FIG. 6.

### Market/Order Assignment

When orders are received from retailer system 30, marketplace system 10 assigns the orders to a supplier based on offers in catalog database system 12. Assignment can be based on various algorithms. In most cases, the most trivial aspect of order assignment is based on the product. In other words, the ordered product must be the same as the product in an offer. Order assignment can also be based on the parameters and rules entered through interface 800 of FIG. 8, as described above. Analytics/forecasting system 16 tracks historical delivery and other aspects of the performance of suppliers and marketplace system 12 uses this data for order assignment.

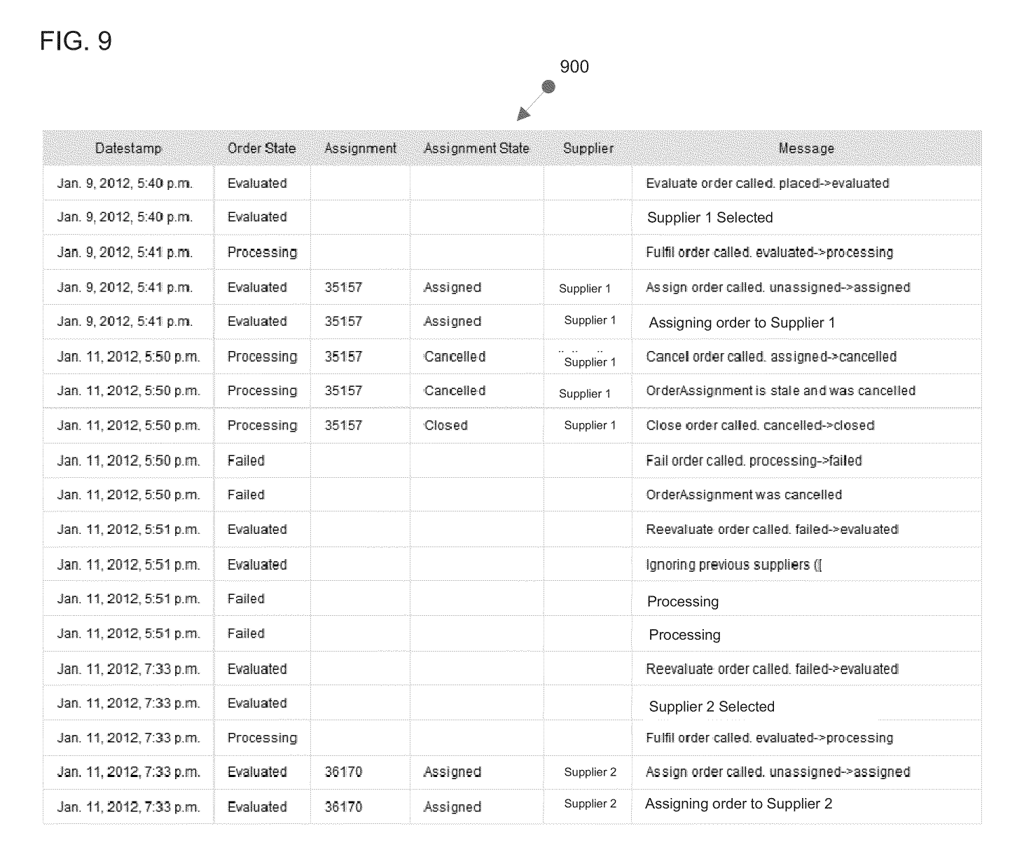

FIG. 9 is a log of order status that illustrates the order assignment process. It can be seen that, on Jan. 9, 2012 at 5:40 pm, an order was received from retailer system 30. Immediately thereafter, Supplier 1 was selected based on the criteria noted above and the order was assigned to Supplier 1 at 5:41 pm. However, on Jan. 11, 2012 at 5:50 pm, the order failed and the assignment was cancelled, due to a lack of order acceptance on the part of Supplier 1. The assignment process was executed again, ignoring offers from Supplier 1 of course, and at 7:33 pm, the order was reassigned to Supplier 2. Of course, if Supplier 2 does not properly acknowledge the order, the assignment process will be conducted again while ignoring offers from both Supplier 1 and Supplier 2 until an order assignment is properly acknowledged. Once an order is acknowledged, marketplace system 10 tracks order status in a known manner and communicates the same to retailer system 30. Products can be shipped from the supplier directly to the customer with a packing slip and other branding of the retailer as described above.

Supply chain platform 100 can be used to match participants in various ways. For example, suppliers 20 can be matched to amalgamate inventory and capabilities. For example one supplier may be set up to ship to a specific country that another supplier wants to server. Alternatively, suppliers can be matched and inventory combined to meet inventory or other requirements of customers or retailers.

Customers choosing to return products can do so with materials and information contained on the packing slip provided by the supply chain platform 100. Included with the packing slip is a retailer-branded return address and postage-paid mailing label and return reason questionnaire. With this material the customer can return their order and supply reason for doing so.

A warehouse operated in connection with supply chain platform 100 collects returned goods, submits reports to supply chain platform 100 (by email, FTP, API, website or other means), aggregates returns by supplier and then ships (in-bulk) returned products to the originating supplier(s), supply chain platform 100 uses information supplied by the warehouse to adjust orders (as well, invoicing and moneys due or owed by Supplier and Retailer), reissue products (replacement orders) and, if applicable, initiate refunds by a means defined by the retailer. Also, replacement orders and refunds can be initiated before receipt of the products at the warehouse, for example should the customer contact the retailer's customer service department.

The disclosed embodiments may be implemented with software, for example modules executed on computing devices. Of course, modules described herein illustrate various functionalities and do not limit the structure of any embodiments. Rather the functionality of various modules may be divided differently and performed by more or fewer modules according to various design considerations. The computing devices can have one or more processors designed to execute instructions, for example computer-readable instructions (i.e., code) stored on a storage device. By executing instructions, the processor(s) may perform the steps and functions disclosed herein. The storage device(s) may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. The computing devices can be any type of computing device such as a server, a personal computer, a laptop, or a mobile device such as a smartphones or a tablet, or any combination of devices.

Embodiments have been disclosed herein. However, various modifications can be made without departing from the scope of the embodiments as defined by the appended claims and legal equivalents.

What is claimed:

1. A computer implemented method for managing a supply chain in an automated manner using a supply chain management platform including at least one computing device, the method comprising:
receiving, by the supply chain management platform, at least one offer from each of plural suppliers, each offer being in the form of a data structure including information relating to products sold by the corresponding supplier, each offer being in a format used by the corresponding supplier, and each offer including a product identifier and price information;
transforming, by the supply chain management system, the offers to standardized offers in a predetermined standard format;
creating an atomic catalog record for each of the products in the offers by normalizing the offers;
recording, by the supply chain management system, the standardized offers and the atomic catalog records in a computer database;
receiving, from a retailer, specification for a product set;
querying the computer database to find standardized offers that correspond to the specification;
creating customized offering lists of available products and corresponding pricing for the retailer based on the results of said querying step; and
presenting, the customized offering lists to the retailer.

2. The method of claim 1, wherein the specification includes preferences selected from the list of, a product type, brand, price-range, price-competitiveness, supplier ethical status, and delivery performance preference.

3. The method of claim 2, further comprising the step of collecting historical supplier delivery performance data and wherein said step of creating a customized offer is based on the historical supplier delivery performance data.

4. The method of claim 1, further comprising the step of calculating supplier trust and reliability data based on historical supplier performance and wherein said step of creating a customized offer is based on the supplier trust and reliability data.

5. The method of claim 1, wherein said step of creating a customized offer includes specifying, to at least one supplier, pricing information or other offer parameters that must be met and receiving at a revised offer from the at least one supplier.

6. The method of claim 1, wherein said step of creating a customized offer comprises creating the customized offers lists based on expected quantities contained in the specification for a product set.

7. The method of claim 1, wherein said step of creating a customized offer comprises creating the customized offers lists based on expected quantities derived from the offers.

8. The method of claim 1, wherein the creating step comprises determining the pricing based on the price information and optimizing the pricing based on supply demand curves determined from offers and other specifications for a product set received from other retailers.

9. The method of claim 1, further comprising the steps of receiving at least one order from the retailer customer and fulfilling the at least one order for the customer.

10. The method of claim 9, wherein the fulfilling step comprises selecting a supplier based on at least one of, the offers, and a supplier historical performance rating.

11. The method of claim 1, wherein the presenting step comprises formatting the customized offer list to conform with a taxonomy specified by the retailer.

12. A computerized supply chain management platform for managing a supply chain in an automated manner, the supply chain management platform including at least one computing device, comprising:
at least one processor;
at least one memory device operatively coupled to the at least one processor and storing computer readable instructions which, when executed by the at least one processor cause the at least one processor to carry out the steps of;
receiving, by the supply chain management platform, at least one offer from each of plural suppliers, each offer being in the form of a data structure including information relating to products sold by the corresponding supplier, each offer being in a format used by the corresponding supplier, and each offer including a product identifier and price information;
transforming, by the supply chain management system, the offers to standardized offers in a predetermined standard format;
creating an atomic catalog record for each of the products in the offers by normalizing the offers;
recording, by the supply chain management system, the standardized offers and the atomic catalog records in a computer database;
receiving, from a retailer, specification for a product set;
querying the computer database to find standardized offers that correspond to the specification;
creating customized offering lists of available products and corresponding pricing for the retailer based on the results of said querying step; and
presenting, the customized offering lists to the retailer.

13. The platform of claim 12, wherein the specification includes preferences selected from the list of, a product type, brand, price-range, price-competitiveness, supplier ethical status, and delivery performance preference.

14. The platform of claim 14, further comprising the step of collecting historical supplier delivery performance data and wherein said step of creating a customized offer is based on the historical supplier delivery performance data.

15. The platform of claim 12, further comprising the step of calculating supplier trust and reliability data based on historical supplier performance and wherein said step of creating a customized offer is based on the supplier trust and reliability data.

16. The platform of claim 12, wherein said step of creating a customized offer includes specifying, to at least one supplier, pricing information or other offer parameters that must be met and receiving at a revised offer from the at least one supplier.

17. The platform of claim 12, wherein said step of creating a customized offer comprises creating the customized offers lists based on expected quantities contained in the specification for a product set.

18. The platform of claim 12, wherein said step of creating a customized offer comprises creating the customized offers lists based on expected quantities derived from the offers.

19. The platform of claim 12, wherein the creating step comprises determining the pricing based on the price information and optimizing the pricing based on supply demand curves determined from offers and other specifications for a product set received from other retailers.

20. The platform of claim 12, further comprising the steps of receiving at least one order from the retailer customer and fulfilling the at least one order for the customer.

21. The platform of claim 20, wherein the fulfilling step comprises selecting a supplier based on at least one of, the offers, and a supplier historical performance rating.

22. The platform of claim 12, wherein the presenting step comprises formatting the customized offer list to conform with a taxonomy specified by the retailer.

23. A computer implemented method for managing a supply chain in an automated manner using a supply chain management platform including at least one computing device, the method comprising:
receiving, from a retailer, a specification for a product set including supplier attributes;
querying a computer database of standardized offers and corresponding atomic catalog records to find standardized offers that correspond to the specification;
creating customized offering lists of available products and corresponding pricing for the retailer based on the results of said querying step; and
presenting, the customized offering lists to the retailer.

24. A computerized supply chain management platform for managing a supply chain in an automated manner, the supply chain management platform including at least one computing device, comprising:
at least one processor;
at least one memory device operatively coupled to the at least one processor and storing computer readable instructions which, when executed by the at least one processor cause the at least one processor to carry out the steps of;
receiving, from a retailer, a specification for a product set including supplier attributes;
querying a computer database of standardized offers and corresponding atomic catalog records to find standardized offers that correspond to the specification;
creating customized offering lists of available products and corresponding pricing for the retailer based on the results of said querying step; and
presenting, the customized offering lists to the retailer.
